(19) United States
(12) Patent Application Publication
(10) Pub. No.: US 2010/0332530 A1
(43) Pub. Date: Dec. 30, 2010

(54) ISLANDS OF DATA

(75) Inventors: Samuel J. McKelvie, Seattle, WA (US); Elissa E. S. Murphy, Seattle, WA (US); Mathew James Dickson, Sammamish, WA (US); Blaine Ryan Young, Bellevue, WA (US); James R. Hamilton, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/492,283

(22) Filed: Jun. 26, 2009

(51) Int. Cl. G06F 17/30; G06F 21/24

(52) U.S. Cl. 707/770; 726/30; 713/189; 707/759; 707/769

(57) ABSTRACT

The claimed subject matter provides a system and/or a method that facilitates generation of islands of data in distributed storage environments such as network-based backup architectures. A partition component can assign a policy to a portion of data within a distributed storage environment to generate an island of data that includes at least the portion of data. In addition, an enforcement component can manages the island of data in accordance with the policy. For instance, the enforcement component can control at least one of access to the island of the data, distribution of the island of data, or deletion of the island of data.

### BACKGROUND

Advances in computer technology (e.g., microprocessor speed, memory capacity, data transfer bandwidth, software functionality, and the like) have generally contributed to increased computer application in various industries. Ever more powerful server systems, which are often configured as an array of servers, are commonly provided to service requests originating from external sources such as the World Wide Web, for example.

In light of such advances, the amount of available electronic data grows and it becomes more important to store such data in a manageable manner that facilitates user friendly and quick data searches and retrieval. Today, a common approach is to store electronic data in one or more databases or data stores. In general, a typical data store can be referred to as an organized collection of information with data structured such that a computer program can quickly search and select desired pieces of data, for example. Commonly, data within a data store is organized via one or more tables. Such tables are arranged as an array of rows and columns.

With the advent of highly sophisticated computer software and/or hardware, servicing areas associated therewith have stormed into existence in order to meet consumer high-demands. Typically, computational services are undertaken upon a client or within a proprietary intranet. Client-side systems are employed to manage relationships between users, software applications, services, and hardware within a client machine, as well as data resident upon a respective intranet. However, in addition to client-side systems providing services, off-site systems (e.g., third party) can also provide services in order to improve data capability, integrity, reliability, versioning, security, and mitigate costs associated therewith.

In general, these services can be employed to manage relationship between users, provide software applications, enhance hardware capabilities, manage data, optimize security, etc. For example, a third party service can enable a client to store data therewith limited solely by the third party capabilities (e.g., hardware, software, etc.). In particular, the off-site or remote data storing services enable users to access data storage via the Internet or the web for data upload or download. Such off-site or remote data storage service providers can provide backup functionality and techniques including redundancy, safe-guarding, privacy, and safe-guards against losing data.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methodologies that facilitate efficient management of aggregate data in a distributed data storage environment such as network-based backup architectures. When a portion of data is committed to the distributed data storage environment, a policy can be selected based upon the originating location of the portion of data (e.g., geographical location, organizational location, etc.), a user associated with the portion of data, or a device associated with the portion of data. The policy can be assigned to the portion of data to generate a virtualized island of data. Accordingly, aggregate data in the distributed data storage environment can be segmented into one or more islands or federations of data by assigning disparate policies to different portions of the aggregate data.

In accordance with another aspect, islands of data can be individually managed accordingly to policies associated therewith. Access to an island can be restricted in accordance with the policies. In addition, movement of data in an island among the distributed storage environment can be administered according to the policies.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an example system that segments aggregate data in a cloud storage location based upon one or more policies in accordance with various aspects.

FIG. 2 illustrates a block diagram that illustrates targets of one or more policies in accordance with various aspects.

FIG. 3 illustrates a block diagram of an example system that facilitates management of policies in accordance with one or more aspects.

FIG. 4 illustrates a block diagram of an example system that manages data in a cloud storage location based upon a policy in accordance with various aspects.

FIG. 5 illustrates a block diagram of an example system that implements hybrid cloud-based and peer-to-peer backup storage in accordance with various aspects.

FIG. 6 illustrates a block diagram of an example system that facilitates management of one or more islands of data in accordance with various aspects.

FIG. 7 illustrates an exemplary methodology for generating islands of data in a distributed storage environment in accordance with various aspects.

FIG. 8 illustrates an exemplary networking environment, wherein the novel aspects of the claimed subject matter can be employed.

FIG. 9 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “cloud,” “peer,” “super peer,” “client,” and the like are intended to refer to a computer-related entity, either hardware, software in execution on hardware, and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

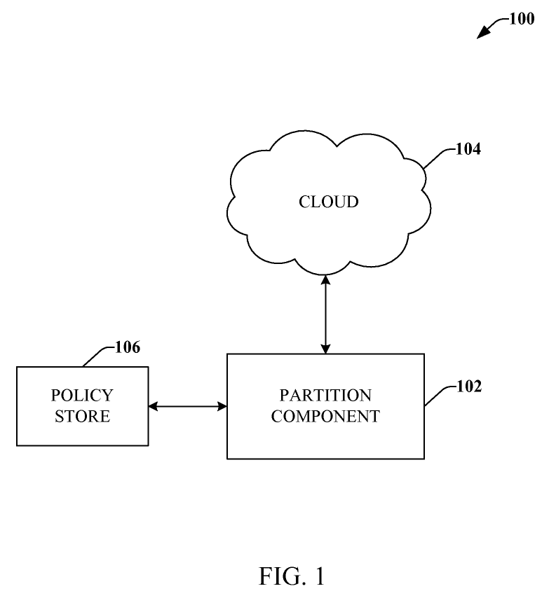

Now turning to the figures, FIG. 1 illustrates a system 100 that segments aggregate data in a cloud storage location based upon one or more policies in accordance with various aspects. In one aspect, data can be managed as an aggregate entity stored in a cloud storage location. The data can originate from one or more users and/or computing devices (e.g., personal computers, laptop computers, servers, portable digital assistants, mobile devices, smart phones, cell phones, portable gaming devices, media players, or any other suitable computing device that can store, manipulate and/or transfer data). Users and/or computing devices can select data (e.g., files, system images, applications, or other information) to be retained in reliable and persistent storage provided by cloud storage locations.

In one example, system 100 can be employed to create islands or federations of data. For instance, a distributed online storage system (such as cloud 104) can retain and manage information as an aggregate without consideration of data content or structure. The distributed storage system can replicate data across storage nodes, transfer data between nodes, and/or perform other data maintenance operations to ensure availability of stored information. System 100 includes a partition component 102 that segments the aggregate data and/or creates islands of data with federated access within cloud 104 (e.g., a distributed online storage system). The partition component 102 can associate one or more policies with a portion of data. The one or more policies can be obtained from a policy store 106 that persists a plurality of policies generated by system 100, users of system 100, computing devices associated with system 100 and the like. In another example, the partition component 102 can assign an identical policy to disparate portions of information. The disparate portions of information associated with a particular policy can be regarded as collected within a virtualized federation or island of data relative to the policy. It is to be appreciated that a portion of data can be associated with one or more islands of data. Accordingly, islands of data can overlap and/or intersect with respect to a portion of data.

In another aspect, the policy store 106 can include a plurality of policies available to system 100 with which islands of data can be generated. A policy can include rules, rights, privileges, permissions, restrictions, etc. that influence access, longevity, modifications, replication, and the like of a portion of data associated therewith. As discussed further infra, policies can be further associated with users, personas of users, computing devices (e.g., user machines, servers, etc.), or combinations thereof.

In an aspect, the partition component 102 can assign a policy to a portion of data retained by cloud 104 based upon a variety of factors. In one example, a policy can be selected and assigned based upon metadata associated with a portion of information. For instance, metadata can indicate an author or originator of the portion of data. The partition component 102 can select and assign a policy to the portion of data in accordance with an identity of the author or originator.

In another example, the partition component 102 can assign polices based upon location. Location can be a geographical location or other location types such as an organizational location (e.g., location, department, division, etc. in an enterprise or other entity), a governmental location (e.g., bureau, department, office, etc.), and the like. For instance, data from a human resources department of an organization can be associated with a respective policy by the partition component 102. In addition, the partition component 102 can assign a different policy to information from a research and development department. In another example, disparate polices can be assigned for data from different geographical locations such as different regions, municipalities, states, provinces, countries, etc.

It is to be appreciated that system 100 can include any suitable and/or necessary interface component(s) (not shown), which provides various adapters, connectors, channels, communication paths, etc. to integrate the partition component 102 into virtually any application, operating and/or database system(s). In addition, the interface component(s) can provide various adapters, connectors, channels, communication paths, etc., that provide for interaction with and between the partition component 102, cloud 104, the policy store 106 and/or any other component associated with system 100.

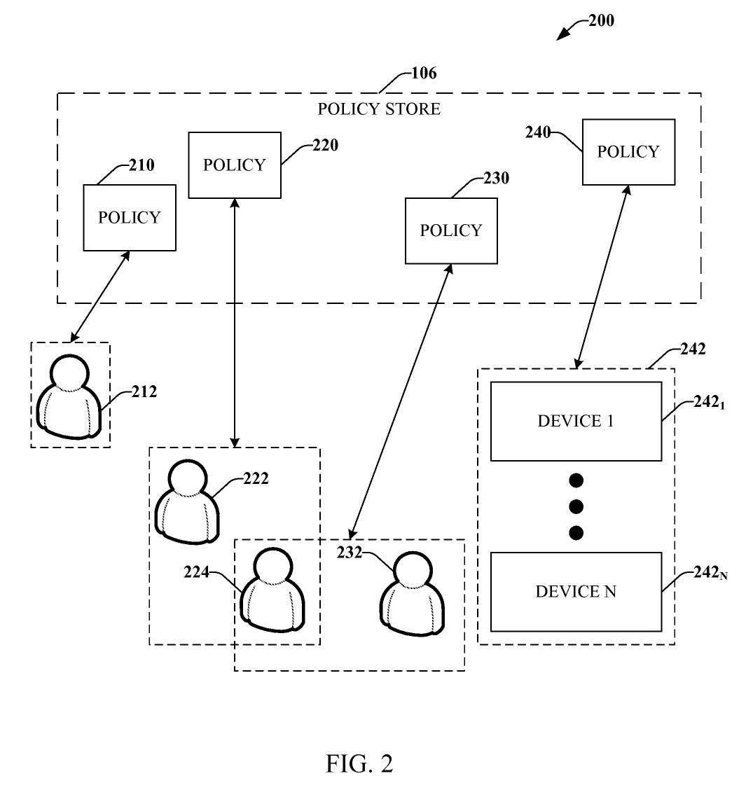

Turning now to FIG. 2, a system 200 is depicted that illustrates further association relative to one or more polices in accordance with various aspects. As illustrated in FIG. 2, system 200 can include a policy store 106 that retains and manages one or more polices such as polices 210-240. While FIG. 2 depicts four polices, it is to be appreciated that a greater or lesser number of polices can be employed.

As discussed supra, polices 210-240 can be assigned to portions of information in a distributed online data storage system to generate virtualized islands of data. To facilitate policy assignment, polices 210-240 can include associations with users, personas of users, devices, and the like. In one example, data originating from a particular user, personas, and/or device can be assigned policy associated therewith.

According to an aspect, policies can be associated with users. For instance, policy 210 can be associated with user 212. Data related to user 212 (e.g., data created, modified, originated, selected for persistent storage, and/or shared by user 212) can be assigned policy 210 when transferred to a distributed online store (e.g., cloud 104) to managed as part of an aggregate mass of information. In another example, a group of users can have a corresponding policy. For instance, policy 220 can be related to a group of users including users 222 and 224. In addition, disparate policies can relate to different personas of a particular user. For example, policy 230 can be related to another group of users that includes user 232 as well as user 224. The group including users 222 and user 224 can correspond to a personal life persona of user 224. Data related to the personal life persona of user 224 can include photos, videos, music, etc. The group including users 232 and 224 can correspond to professional persona of user 224. Data related the professional persona of user 224 can include, for example, business information. Since data from a personal persona can be distinct from data from a professional persona in terms of content, sensitivity, desire to share with others (e.g., co-workers, family), etc., different policies can be assigned to such data. Thus, policies can be associated with overlapping groups of users with respect to one or more users.

In another aspect, polices can be associated with computing devices such as client machines, servers, mobile devices, and the like. Such association can facilitate selection and assignment of appropriate policies to portions of information in an online distributed storage environment. For example, policy 240 can relate to a set of devices 242 that can include N devices where N is an integer greater than or equal to one.

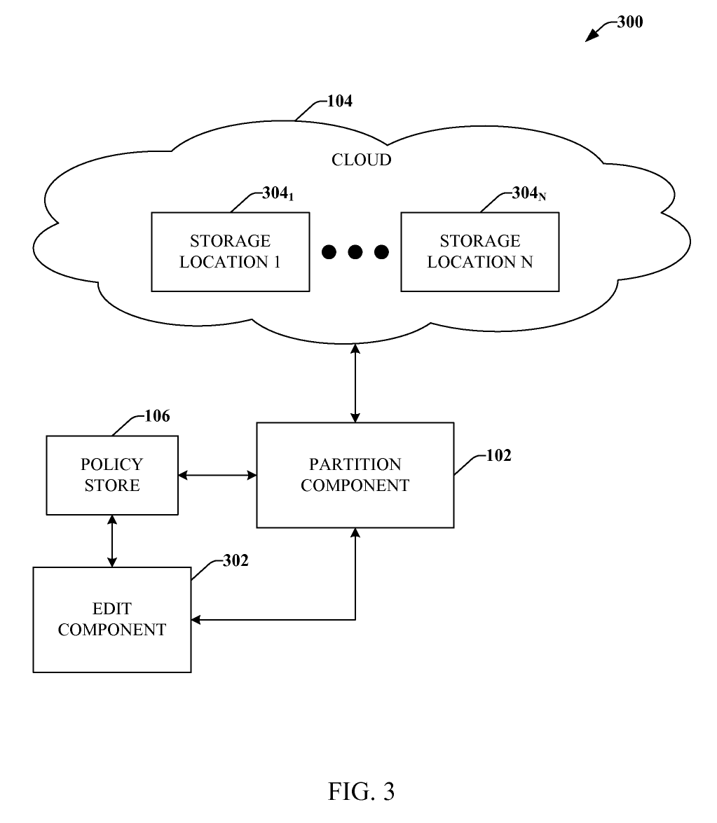

FIG. 3 illustrates a system 300 that facilitates management of policies in accordance with one or more aspects. System 300 can include a partition component 102 that can create virtualized islands or federations of data in a distributed storage environment such as cloud 104. In an aspect, the partition component assigns one or more policies from a policy store 106 to disparate portions of information in cloud 104 such that data assigned a similar policy are collected in a virtualized island or federation. It is to be appreciated that partition component 102, cloud 104 and policy store 106 that can perform substantially similar functions like named components described supra with respect to previous figures.

System 300 can include an edit component 302 that enables management of policies employed to construct virtualized islands of data in cloud 104. The edit component 302 can facilitate creation, modification, and/or deletion of policies in policy store 106. For instance, rules, rights, privileges, and/or permissions included in a policy can be edited via the edit component 302. For example, a user can utilize the edit component 302 to generate one or more policies applicable to data created by the user and/or data from one or more computing devices operated by the user. In addition, the edit component 302 can be utilized to combine two or more policies. In another aspect, the edit component 302 can be utilized to control assignment of policies by the partition component 102. In one example, a particular policy can be explicitly selected and assigned to a portion of data of a user via the edit component 302.

In accordance with another aspect, the cloud 104 can include a plurality of storage locations 304 (e.g., depicted in FIG. 3 as storage locations 304_{I} through 304_{N} where N is an integer greater than or equal to one). The storage locations 304 can include client machines such as, but not limited to, personal computers, mobile devices, laptop computers, PDAs, or other suitable computing devices. In addition, the storage locations 304 can further include servers (e.g., enterprise servers, home servers, etc.), content distribution networks, and so on. Cloud 104 can include any collection of resources (e.g., hardware, software, combination thereof, etc.) that are maintained by a party (e.g., off-site, on-site, third party, etc.) and accessible by an identified user over a network (e.g., Internet, wireless, LAN, cellular, WiFi, WAN, etc.). For instance, users can access, join and/or interact with cloud 104 (e.g., via cloud backup service offered by an entity) and, in turn, store data (e.g., backup information and/or chunks thereof) at the cloud 104 which provide cheap storage with high availability.

Cloud 104 can manage locality of information retained therein. Cloud 104 can distribute chunks of information among storage locations 304 such that availability and optimal locality is maintained while reducing storage costs, bandwidth costs, and latency times upon restoration. Cloud 104 can evaluate characteristics of storage locations 304 and distribute chunks of backup data accordingly. The characteristics can include availability of storage locations (e.g., based on device activity levels, powered-on or powered-off status, etc.), available storage space at locations, cost of storage at locations, cost of data transfer to/from locations, network locality of locations (e.g., network topology), and the like. In one example, cloud 104 can distribute more data to storage locations with higher storage capability and availability than to other storage locations (e.g., normal client machines).

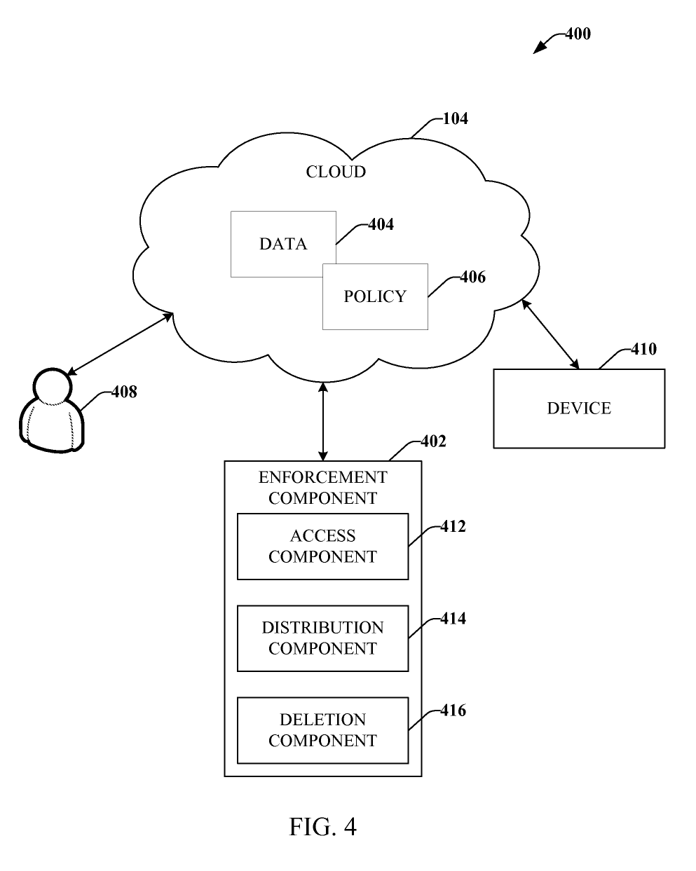

Turning to FIG. 4, illustrated is a system 400 that that manages data in a cloud storage location based upon a policy in accordance with various aspects. As depicted in FIG. 4, system 400 can include cloud 104 that can provide a distributed data storage environment for reliable and efficient storage of data for a variety of applications (e.g., backup systems, content distribution systems, peer-to-peer applications, file sharing, etc.). As discussed herein, islands of data can be created in cloud 104 via assignment of policies to portions of information. Disparate data within different islands of data can be associated with diverse rules related to access, modification, longevity (e.g., permanence, life span, etc.), transferability, replication, and the like. Rules applied to data in a particular island of data can be governed by one or more policies assigned thereto.

In an aspect, system 400 can include an enforcement component 402 that implements rules, permission and/or other restrictions specified in policies associated with one or more islands of data within cloud 104. For instance, the enforcement component 402 can manage an island that includes data 404 such that the enforcement component 402 administers the island in accordance with policy 406 associated with data 404. In one aspect, the enforcement component 402 can include an access component 412 that controls access to the data 404 based upon permissions in policy 406. For example, user 408 can attempt access to data 404. Prior to a grant, the access component 412 can ascertain an identity of user 408 and/or authenticate user 408. For instance, the access component can identify user 408 and verify that policy 406 associated with data 404 specifies that user 408 can interact with the island of data 404. It is to be appreciated that access component 412 can employ a variety of mechanisms to enforce access policies for an island of data. In one example, the access component 412 can utilize username and password techniques to identify and authenticate users. In another example, the access component 412 can employ encryption and/or cryptography to obfuscate data or establish secure channels. User 408 can be issued a key by access component 412 when policy 406 indicates proper permissions. User 408 can utilize the key to decrypt data 404. In addition, user 408 can employ the key to establish a secure channel via which access to data 404 can occur.

In accordance with another aspect, the enforcement component 402 can include a distribution component 414 that controls movement, distribution, and/or replication of data 404 based upon policy 406. For instance, the policy 406 can specify restrictions on distribution of data 404 within a distributed storage environment. The distributed storage environment can be a hybrid peer-to-peer/cloud storage environment. Cloud 104 can interact with one or more remote storage locations (not shown) such as one or more trusted peer(s) and/or super-peer(s). To facilitate distribution or redistribution of data among storage locations to ensure reliability and availability of information, peer(s), super-peer(s), and/or cloud 104 can communicate information between each other. In addition, it can be appreciated that partition component 102, policy store 106, edit component 302, enforcement component 402, and/or any other components of systems 100, 200, 300, or 400 could additionally be associated with the one or more storage locations associated with cloud 104 in a hybrid environment. Further detail regarding techniques by which peer(s), super-peer(s), and cloud storage locations can be utilized, as well as further detail regarding the function of such entities within a hybrid architecture, is provided infra.

In one example, policy 406 can specify restriction on storage locations that can retain data 404 or a portion of data 404. For instance, policy 406 can indicate that device 410 is restricted from data 404. The distribution component 414 can prevent transfer or replication of data 404 to device 410. In another example, the distribution component 414 can prevent a user (e.g., user 408) from accessing data 404 via device 410 even when the user is granted access by the access component 412. Accordingly, a user can be trusted access by policy 406 while a device employed by the user is not trusted.

The distribution component 414 can employ hardware-based trust systems to facilitate enforcement of movement restrictions placed on an island of data by a policy. Hardware-based trust systems can employ secure chips or other processing devices that enable software (e.g., operating systems, applications, firmware, etc.) to be authenticated, verified and signed. The trust system can identify software on a device as genuine and therefore, trusted. In one aspect, the distribution component 414 can block replication of data 404 to non-trusted devices when specified by policy 406.

In another aspect, the enforcement component 402 can include a deletion component 416 that enables removal of data 404 from cloud 104 and any other storage locations in a hybrid architecture that store data 404. In one example, the deletion component 416 can perform a secure delete of data 404 from storage locations. For instance, the deletion component 416 can overwrite data 404 with random information (e.g., ones and zeroes) a plurality of times to prevent recovery of original information. In another example, the deletion component 416 can encrypt data 404 with a temporary key and subsequently destroy the key to prevent extraction of contents of data 404. In addition, the secure delete and/or encryption can be carried out across storage locations. For instance, the deletion component 416 can be distributed among storage locations in cloud 104 and/or any other storage locations participating in a hybrid architecture. Such storage locations and be included in a trust verified by hardware-based trust techniques, for example.

It should be appreciated that storage locations associated with the distributed storage environment (e.g., peers, super-peers, cloud 104, etc.) may not be included in a trust managed by the enforcement component 402 and/or the policy 406. For instance, a particular storage location can be included in the distributed storage environment but not a member of an overall trusted computing base associated with the enforcement component 402. In accordance with an aspect, there can be at least three trust entity classes associated with an island of data corresponding to data 404 and policy 406 such that a particular storage location in the distributed storage environment is a member of at least one class. In one example, the three entity types associated with an island can include a data client entity, a trusted island manager entity, and an untrusted infrastructure entity. It should be appreciated that the classes described herein are examples and the claims are not limited to such classes.

The data client entity can authenticate with and communicate security with a trusted island manager entity associated with an island of data. The data client entity can publish, read, and/or modify data and/or policies through the trusted island manager entity subject to constraints enforces by the trusted island manager entity. The data client entity type can include any components (e.g., runtime libraries, local storage, etc.) which are trusted by a given data client, but which are not trusted by all data client entities accessing the island of data. The data client can utilize untrusted infrastructure entities to facilitate efficient communication with other entities, or for efficient storage/caching. However, it is to be appreciated that the data client does not trust the untrusted infrastructure entities to enforce policy constraints. Each data client instance can be a distinct trust entity. However, there need not be an inherent direct trust between data client entities.

The trusted island manager entity can include any components utilized by data client entities to access a particular island of data. The trusted island manager entity can include the enforcement component 402, for example. In addition, the trusted island manager entity can include storage, communication, encryption or other suitable components to maintain policy constraints for an island of data.

The untrusted infrastructure entity can include components employed by data client entities and/or the trusted island manager entity to facilitate communication between entities and/or data storage locations of an island of data. The untrusted infrastructure entity can include unsecured internet data transports (e.g., TCP, HTTP, email, etc.), cloud storage, CDNs, and the like. In an aspect, statistical techniques can be employed to allow limited trust to be extended to the untrusted infrastructure entity. Such limited trust can be based, for example, on a likelihood (or unlikelihood) of malicious collusion between two randomly selected nodes classes as untrusted infrastructure entities. For instance, while no single node can be trusted to prevent deletion or corruption of stored data, it can safe to assume that at least one of N randomly selected nodes will succeed in preventing deletion or corruption. In another example, while no single node can be trusted to prevent revelation of an IP address of a node to which it is connected, it is often safe to assume that two randomly selected nodes do not maliciously cooperate for the purposes of revealing correlations of IP address connectivity across both nodes.

In another aspect, it is to be appreciated that set of storage locations (e.g., peers, data client entities, etc.) can coordinate to establish a trusted island of data relationship. For instance, a set of data clients can self-select a trusted island manager entity within the set to enforce and/or maintain an island of data.

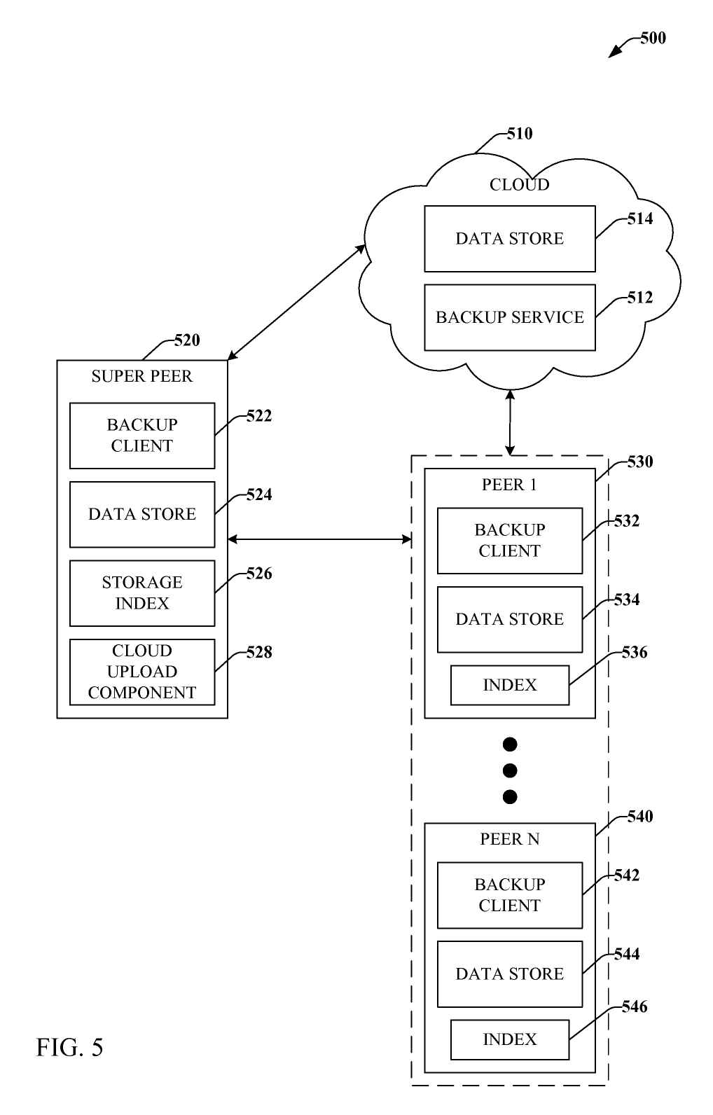

Referring next to FIG. 5, illustrated is a system 500 that implements hybrid cloud-based and peer-to-peer storage in accordance with various aspects. As system 500 illustrates, a network implementation can utilize a hybrid peer-to-peer and cloud-based structure, wherein a cloud 510 interacts with one or more super peers 520 and one or more peers 530-540.

In accordance with one aspect, cloud 510 can be utilized to remotely implement one or more computing services from a given location on a network/internetwork associated with super peer(s) 520 and/or peer(s) 530-540 (e.g., the Internet). Cloud 510 can originate from one location, or alternatively cloud 510 can be implemented as a distributed Internet-based service provider. In one example, cloud 510 can be utilized to provide backup or other storage functionality to one or more peers 520-540 associated with cloud 510. Accordingly, cloud 510 can implement a backup service 512 and/or provide associated data store 514.

In one example, data storage 514 can interact with a backup client 522 at super peer 520 and/or backup clients 532 or 542 at respective peers 530 or 540 to serve as a central storage location for data residing at the respective peer entities 520-540. In this manner, cloud 510, through data storage 514, can effectively serve as an online “safe-deposit box” for data located at peers 520-540. It can be appreciated that backup can be conducted for any suitable type(s) of information, such as files (e.g., documents, photos, audio, video, etc.), system information, and/or chunks of files or system information. Additionally or alternatively, distributed network storage can be implemented, such that super peer 520 and/or peers 530-540 are also configured to include respective data storage 524, 534, and/or 544 for backup data associated with one or more machines on the associated local network. In another example, techniques such as de-duplication, incremental storage, and/or other suitable techniques can be utilized to reduce the amount of storage space required by data storage 514, 524, 534, and/or 544 at one or more corresponding entities in the network represented in FIG. 5 for implementing a cloud-based backup service.

In accordance with another aspect, cloud 510 can interact with one or more peer machines 520, 530, and/or 540. As illustrated in FIG. 5, one or more peers 520 can be designated as a super peer and can serve as a liaison between cloud 510 and one or more other peers 530-540 in an associated local network. It should be appreciated that any suitable peer 530 and/or 540, as well as designated super peer(s) 520, can directly interact with cloud 510 as deemed appropriate. Thus, it can be appreciated that cloud 510, super peer(s) 520, and/or peers 530 or 540 can communicate with each other at any suitable time to synchronize files or other information between the respective entities associated with system 500.

In one example, super peer 520 can be a central entity on a network associated with peers 520-540, such as a content distribution network (CDN), an enterprise server, a home server, and/or any other suitable computing device(s) determined to have the capability for acting as a super peer in the manners described herein. In addition to standard peer functionality, super peer(s) 520 can be responsible for collecting, distributing, and/or indexing data among peers 520-540 in the local network. For example, super peer 520 can maintain a storage index 526, which can include the identities of respective files and/or file segments corresponding to peers 520-540 as well as pointer(s) to respective location(s) in the network and/or in cloud data storage 514 where the files or segments thereof can be found. In another aspect, peers 530 and 540 can include respective indexes 536 and 546 which can include local cache of at least a portion of storage index 526. Although shown in FIG. 5 to be associated with super-peer 520, it is to be appreciated that the storage index 526 can be managed by cloud 510, peers 530-540, and/or distributed among super peer 520, cloud 510 and peers 530-540. Additionally or alternatively, super peer 520 can act as a gateway between other peers 530-540 and a cloud service provider 510 by, for example, uploading respective data to the cloud service provider 510 at designated off-peak periods via a cloud upload component 528. However, peers 530-540 can communicate information directly to cloud service provider 510.

It is to be appreciated that the data stores illustrated in system 500 (e.g., data stores 514, 524, 534, and 544) can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store of the subject systems and methods is intended to comprise, without being limited to, these and any other suitable types of memory. In addition, it is to be appreciated that the data stores can be a server, a database, a hard drive, a pen drive, an external hard drive, a portable hard drive, and the like.

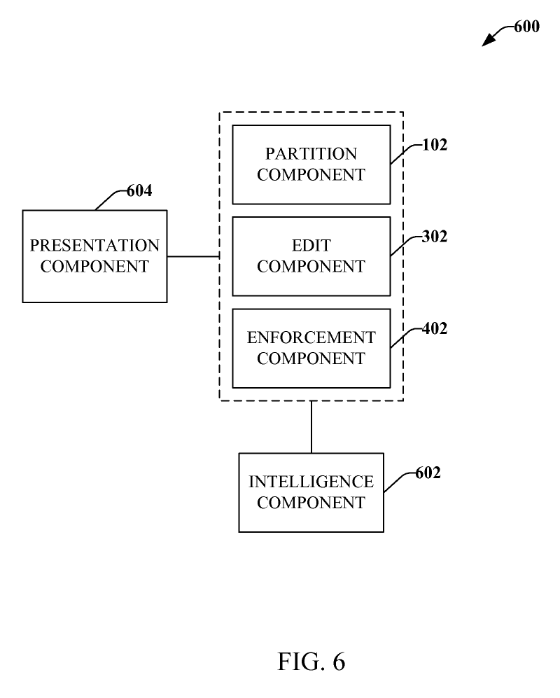

FIG. 6 illustrates a system 600 that facilitates management of one or more islands of data in distributed storage environment in accordance with various aspects. The system 600 can include the partition component 102, the edit component 302, and the enforcement component 402, which can be substantially similar to respective components, boxes, systems and interfaces described in previous figures. The system 600 further includes an intelligence component 602. The intelligence component 602 can be utilized by the partition component 102, the edit component 302, or the enforcement component 402 to infer, for example, policies to assign to portions of data to generate islands, rules to incorporate into policies, effectuate policy decisions and the like.

The intelligence component 602 can employ value of information (VOI) computation in order to generate federations or islands of data For instance, by utilizing VOI computation, the most ideal and/or appropriate policies to assign to a portion of data can be determined. Moreover, it is to be understood that the intelligence component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The partition component 102, edit component 302, and enforcement component 402 can further utilize a presentation component 604 that provides various types of user interfaces to facilitate interaction between a user and any component coupled to system 600 (e.g., backup clients, backup service, etc.). As depicted, the presentation component 604 is a separate entity that can be utilized with the partition component 102, edit component 302, and enforcement component 402. However, it is to be appreciated that the presentation component 604 and/or similar view components can be incorporated into the partition component 102, edit component 302, enforcement component 402 and/or a stand-alone unit. The presentation component 604 can provide one or more graphical user interfaces (GUIs), command line interfaces, and the like. For example, a GUI can be rendered that provides a user with a region or means to load, import, read, edit etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

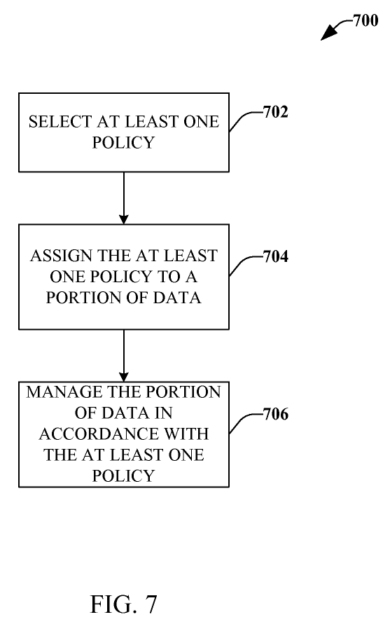

FIG. 7 illustrates a methodology and/or flow diagram in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 7, a method 700 for generating islands of data in a distributed storage environment is illustrated. At reference numeral 702, at least one policy is selected. The policy can be selected based upon a location of a user, computing device and/or data associated with a user or computing device. The location can be a geographical location. In another example, the location can be an organizational location such as a department or division of a business, government, and so on. In another example, the policy can be selected based upon metadata or other tags included in a portion of data.

At reference numeral 704, the at least one policy is assigned to a portion of data. In one aspect, the portion of data can be stored in a distributed storage environment (e.g., cloud storage location(s), hybrid peer-to-peer/cloud storage architecture, etc.) as part of an aggregate. At reference numeral 706, the portion of data is managed in accordance with the at least one policy. For instance, access to the portion of data, replication of the portion of data, movement of the portion of data, longevity of the portion of data, viewing rights of the portion of data, and other maintenance operations or rules specified in the policy are enforced relative to the portion of data.

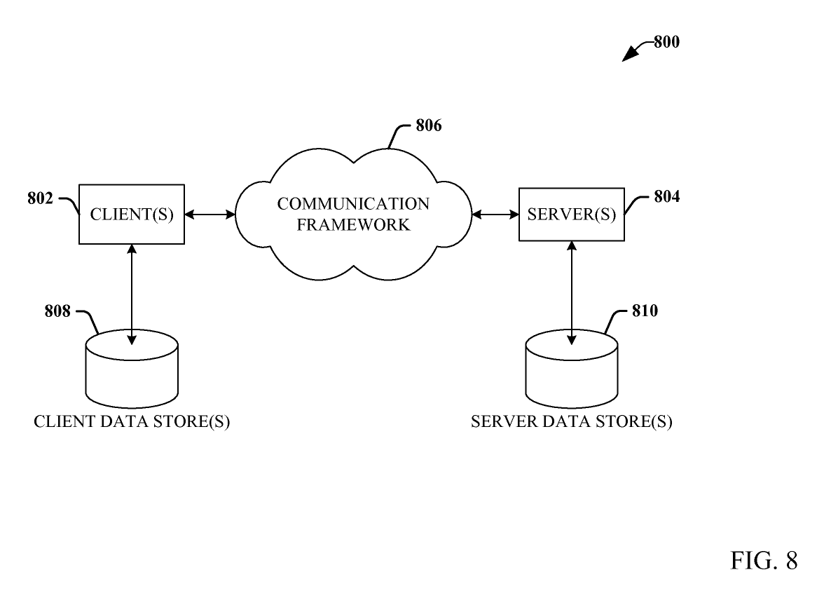

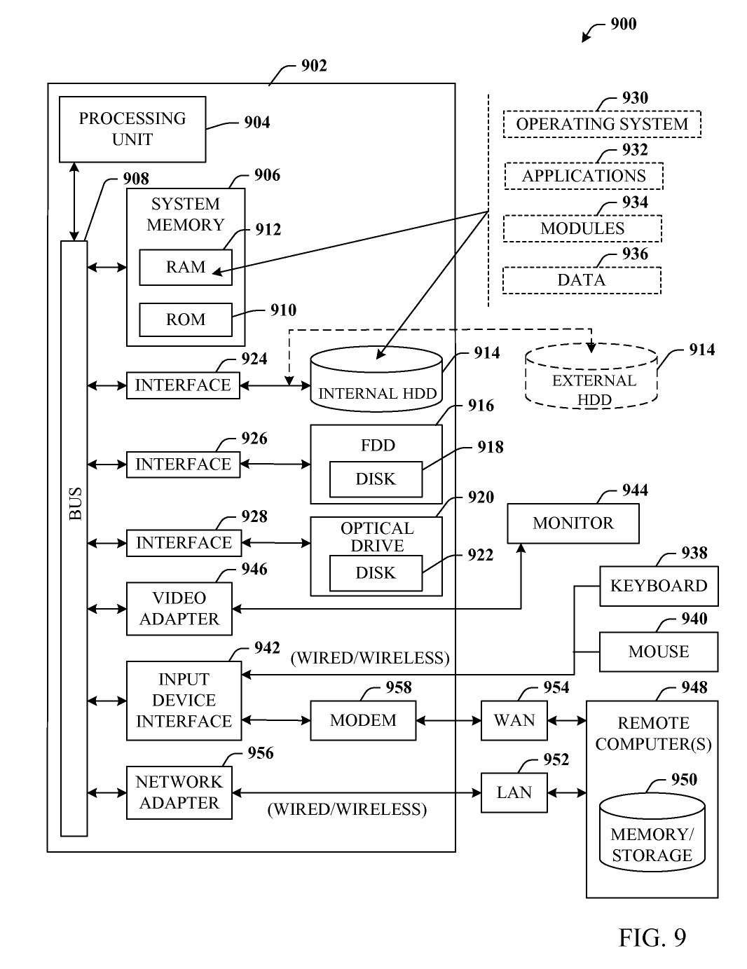

In order to provide additional context for implementing various aspects of the claimed subject matter, FIGS. 8-9 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Referring now to FIG. 8, there is illustrated a schematic block diagram of an exemplary computer compilation system operable to execute the disclosed architecture. The system 800 includes one or more client(s) 802. The client(s) 802 can be hardware and/or software (e.g., threads, processes, computing devices). In one example, the client(s) 802 can house cookie(s) and/or associated contextual information by employing one or more features described herein.

The system 800 also includes one or more server(s) 804. The server(s) 804 can also be hardware and/or software (e.g., threads, processes, computing devices). In one example, the servers 804 can house threads to perform transformations by employing one or more features described herein. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

With reference to FIG. 9, an exemplary environment 900 for implementing various aspects described herein includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, a serial port, an IEEE-1394 port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10 BaseT wired Ethernet network.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates segmentation of aggregate data, comprising:
a processor coupled to a memory that retains computer-executable instructions, the processor executes:
a partition component that generates virtualized islands of data within a distributed storage environment, the partition component assigns a policy to a portion of data to generate an island of data that includes at least the portion of data; and
an enforcement component that manages the island of data in accordance with the policy, the enforcement component controls at least one of access to the island of the data, distribution of the island of data, or deletion of the island of data.

2. The system of claim 1, wherein the policy includes rules related to at least one of access to the portion of data, longevity of the portion of data, distribution of the portion of data, replication of the portion of data, or deletion of the portion of data.

3. The system of claim 1, wherein the island of data includes information disparate from the portion of data, the partition component assigns the policy to the disparate information to include the disparate information in the island of data.

4. The system of claim 1, wherein the partition component selects the policy to assign to the portion of data based at least in part on a location of the portion of data, the location of the portion of data is at least one of a geographical location or an organizational location.

5. The system of claim 1, wherein the policy is associated with at least one of a user, a group of users, a persona of a user, or a group of devices.

6. The system of claim 1, further comprising an edit component that enables at least one of creation of, deletion of, or modification to one or more policies.

7. The system of claim 1, wherein the enforcement component includes an access component that controls access to the portion of data in accordance with permissions included in the policy.

8. The system of claim 7, the access component employs a cryptography key to manage access to the portion of data.

9. The system of claim 1, wherein the enforcement component includes a distribution component that controls movement of the portion of data within the distributed storage environment.

10. The system of claim 1, wherein the enforcement component includes a deletion component that removes the portion of data from the distribute storage environment.

11. The system of claim 10, wherein the deletion component overwrites the portion of data a plurality of times with random information.

12. The system of claim 11, wherein the deletion component generates a temporary key and utilizes the temporary key to encrypt the portion of data.

13. The system of claim 1, wherein the distributed storage environment includes a set of storage locations.

14. The system of claim 13, wherein the set of storage locations include one or more of peers or cloud storage locations.

15. The system of claim 1, wherein the enforcement component utilizes hardware-based trust systems to implement the policy assigned to the portion of data.

16. A method for generating virtualized federations of data in a distributed data storage environment, comprising:
employing a processor executing computer-executable instructions stored on a computer-readable storage medium to implement the following acts:
selecting at least one policy based at least in part on a portion of data, an owner of the portion of data, or a location of the portion of data;
associating the at least one policy with the portion of data, wherein the portion of data is stored in a distributed data storage environment as part of an aggregate; and
managing the portion of data in accordance with one or more rules specified in the associated at least one policy.

17. The method of claim 16, wherein managing the portion of data comprises restricting access to the portion of data based upon permissions specified in the at least one policy.

18. The method of claim 16, wherein managing the portion of data comprises limiting movement of the portion of data within the distributed data storage environment to nodes specified in the at least one policy.

19. The method of claim 16, wherein the distributed storage environment includes a plurality of storage locations, the plurality of storage locations include one or more peer machines or cloud storage locations.

20. A system that facilitates creation of islands of data among a data aggregate, comprising:
at least one processor that executes computer-executable code stored in memory to effect the following:
means for selecting a policy based in part on at least one of a location of a portion of information, a user associated with the portion of information, or a device associated with the portion of information, the portion of data in part of a data aggregate stored in a distributed storage environment;
means for assigning the selected policy to the portion of information to generate an island of data; and
means for managing the portion of information in accordance with the assigned policy, the means for managing include at least one of:
means for controlling access to the portion of information;
means for restricting movement of the portion of information within the distributed storage environment; or
means for removing the portion of information from the distributed storage environment.
